(19) United States
(12) Patent Application Publication
(10) Pub. No.: US 2003/0037097 A1
(43) Pub. Date: Feb. 20, 2003

(54) Accessing information content

(76) Inventors: Andre Philippe Meyer, Eindhoven (NL); Natasha Kravtsova, Eindhoven (NL)

Correspondence Address: U.S. Philips Corporation, 580 White Plains Road, Tarrytown, NY, 10591, US

(21) Appl. No.: 10/197,342

(22) Filed: Jul. 17, 2002

(30) Foreign Application Priority Data
Jul. 20, 2001 (EP) 01202787.6

(51) Int. Cl. G06F 15/16; G06F 17/30; G06F 7/00

(52) U.S. Cl. 709/202; 707/10

(57) ABSTRACT

Disclosed is a method of retrieving information content in a computer network. The method comprises the steps of specifying a search criterion on a user computer (101) of the computer network; transmitting a first mobile agent (111a) including computer-executable program code means and the search criterion to at least a first host computer (102, 103, 104, 105, 106) of the computer network; generating a search result by means of the received first mobile agent indicative of whether the information content corresponding to the specified search criterion is available on the first host computer and, if the information content is available on the first host computer, initiating downloading the information content from the first host computer to a predetermined target computer.

This invention relates to retrieving information content in a computer network.

An increasing use of computer networks, such as the Internet, for information retrieval has made effective search mechanisms for accessing information content from a computer network desirable.

The international patent application WO 99/27681 discloses a system for providing personalised audio contents to users via an electronic network. The system comprises a server with a database and a player component. Upon request from a client computer, the player component provides a search mode allowing a user to search for music content in the database of the server or other databases connected to the network.

However, the above prior art method involves the problem that the capacity of the system is limited by the bandwidth available to the server. Hence, if a large number of users try to download data from the server, the time necessary for the download is increased. Furthermore, other network traffic, in particular to and from that server, may also be adversely affected by the traffic generated by the downloads.

The above and other problems are solved by a method of retrieving information content in a computer network, the method comprising the steps of

specifying a search criterion on a user computer of the computer network;

transmitting a first mobile agent including computer-executable program code means and the search criterion to at least a first host computer of the computer network;

generating a search result by means of the received first mobile agent indicative of whether the information content corresponding to the specified search criterion is available on the first host computer; and

if the information content is available on the first host computer, initiating downloading the information content from the first host computer to a predetermined target computer.

Hence, according to the invention the search process is performed by means of computer-executable instructions which are transmitted to one or more remote host computers of the computer network where they are executed. If the information content is localised on one of the remote sites, the download process is performed from that site, without the need of directing the data via a central server. Hence, as the location of the contents is distributed among a number of server computers, the total resource requirements for all searches and download processes are likewise distributed among a number of computers. Consequently, the search performance is not limited by the resources, e.g. the available bandwidth, of a single server.

The term mobile agent comprises a software entity which includes computerexecutable instructions defining the operations to be performed on a host computer and data items indicative of the state of execution of the mobile agent. A mobile agent may execute at least a sub-set of its instructions on a computer, thereby interacting with an execution environment of that computer and updating its own state of execution. Furthermore, the mobile agent may migrate to one or more other computers and execute at least a sub-set of its instructions on the other computer. The execution of the computer-executable instructions and the migration to another computer do not require any user input. Hence, a mobile agent may autonomously perform predetermined tasks on a plurality of computers taking instructions and results form these tasks with it to another computer.

It is a further advantage of the invention that on a participating computer only an execution environment for the mobile agents needs to be installed, while the other parts of the user application are implemented as agents. Since agents comprise their own executable code, they may coexist with other agents even though they correspond to different versions of the execution environment. Hence, the need for updating the software installation on the individual computers in order to ensure compatibility between different versions is greatly reduced.

Furthermore, since the communication between the computers is based on agents, the amount of signalling between participating computers is reduced compared to a system where a computer program is executed on the user's computer and communicates with other computers, e.g. via messages comprising queries and the corresponding responses or via a series of remote procedure calls. It is known to interrogate other host computers via remote procedure calling. However, this prior art method has the disadvantage that it generates a large amount of network traffic and requires the participating host computers to be online, since each interaction between the client computer and the server entails two acts of communication: one to ask the server to perform a procedure and another to acknowledge that the server did so. For example, to discover information on another host computer via procedure calling, a client computer may interrogate a server computer via a series of procedure calls, each yielding an acknowledgment or result, e.g. about whether the server computer is on-line, about the directory structure of the server computer, the location of searchable files in its directory structure, etc.

According the invention, on the other hand, a suitably configured mobile agent is transmitted to the server computer and, subsequently, the communication is performed locally on the server computer between the mobile agent and the server computer. Therefore, it is an advantage of the invention that the different host computers do not have to repeatedly exchange information, thereby minimising the amount of on-line signalling between the participating hosts. Furthermore, the client computer does not need to be on-line at the same time as the server computer. The client computer only needs to be connected to the network long enough to send the mobile agent on its way and, at a later point in time, to receive back the agent and/or the results of all its actions. The client computer does not need to remain online while the mobile agent carries out its assignment.

It is a further advantage of the invention that mobile agents carry their own program code, thereby allowing the performance of tasks on the host computer which the host computer originally was not programmed to perform. Consequently, the method provides a high degree of customisability and flexibility.

It is a further advantage of the invention, that mobile agents may define their own communications protocol with their originating server. As a result, user-specific encryption and payment schemes may be enabled.

The term computer according to the invention comprises any computer which, at least temporarily, may be connected to a computer network. Examples of such computers comprise stationary or portable PCs which may be connected to a computer network via a local area network, a telephone line, or the like. Other examples include portable electronic devices, such as mobile terminals, e.g. mobile telephones, PDAs, communicators, hand-held computers, or other electronic equipment which may connect to a computer network.

The term information content comprises any type of searchable information content, such as video content, audio content, graphics, images, pictures, animations, other multimedia content, information content in text form, or the like. The information content may be stored in suitable file formats, such as MPEG2, MPEG3, MPEG4, Quicktime, Shockwave, etc.

The term computer network comprises any communications network connecting computers, e.g. a LAN, an intranet, a TCP/IP based network such as the Internet, a wireless telecommunications network, e.g. using WAP, or the like.

It is a further advantage of the invention that the information content stored on a plurality of host computers is accessible for the search process, thereby providing a large search base and increasing the probability of finding the desired content.

It is a further advantage of the invention, that the search process may proceed even if some computers of the network are off-line, thereby making the search process robust.

In a preferred embodiment of the invention, the method further comprises the step of initiating transmitting a second mobile agent, corresponding to the first mobile agent, from the first host computer to at least a second host computer of the computer network, if the information content is not available on the first host computer.

Consequently, as the mobile agent autonomously initiates a continuation of the search process on another computer, the search process proceeds without the need for further interaction with the user's computer during the search process. Thus, the search process may be performed independently of whether the user's computer is on-line during the search, thereby providing a flexible search method which allows a user to initiate a search process and, subsequently, use his/her computer for other tasks, disconnect the computer from the network, or even turn off the computer. Even though the user's computer may have been disconnected from the network, the search process continues autonomously without the need for further user interaction or further interaction with, or use of, resources of the user's computer. In particular this is an advantage for computers with temporary network connections, such as PCs connected to the Internet via a telephone line, mobile communications devices, or the like. It is a further advantage of the invention, that the user does not need to supervise or interact with the search process, thereby decreasing the time which the user needs to spend on the search. The second mobile agent may be the first mobile agent with updated status information. Alternatively, the second mobile agent may be a copy of the first mobile agent.

In a preferred embodiment of the invention, the computer network is logically divided into a number of subnets, a first one of the number of subnets comprising the first host computer; and the method further comprises the steps of

searching for the information content on the host computers of the first subnet;

initiating transmitting a second mobile agent, corresponding to the first mobile agent, from the first host computer to at least a first host computer of a second subnet, if the information content is not available on the host computers of the first subnet.

Hence, the search process is performed according to a hierarchical search strategy, i.e. searching on a first predetermined subnet of the computer network before searching on a second subnet. Consequently, a particularly effective search is achieved which only requires little network resources and reducing the necessary search times.

It is a further advantage of this embodiment that Subnets allow the implementation of mirror images where contents of one host of a subnet is copied to other hosts of that subnet.

A subnet may comprise hosts located in a given geographic area, hosts providing information content of a given type, e.g. music of a certain genre such as a jazz subnet, a classical subnet, etc., or hosts grouped according to another suitable criteria. Preferably, each host belongs to at least one subnet, but a host may belong to different subnets.

Preferably, the subnets are formed based on the location of the host computers within the topology of the computer network. Preferably other criteria to form subnets, e.g. based on genre, may be used to form additional, auxiliary subsets of hosts. These subsets may coexist with the main topology-based subnets and they may be used to simplify the search, e.g. by limiting it to a genre or by performing a hierarchical search within a main subnet.

In another preferred embodiment the step of initiating downloading the information content further comprises the steps of

transmitting a message indicative of a location of the information content from the first host computer to the user computer;

in response to the received message transmitting a third mobile agent to the first host computer of the computer network, the third mobile agent being configured to initiate downloading the information content from the indicated location.

Consequently, the method according to this embodiment involves different types of agents each performing different tasks. Search agents are responsible of locating the desired content on the computer network, while download agents perform the actual download process. Hence, each agent only requires a smaller amount of executable code adapted to perform its specific tasks, thereby reducing the amount of data to be transmitted and, thus, further increasing the efficiency of the method.

Further preferred embodiments of the invention are disclosed in the dependent claims.

The invention further relates to a method of accessing information content on a computer network from a user computer, the method comprising the steps of

specifying a search criterion on the user computer; and

transmitting a first mobile agent including computer-executable program code means and the search criterion to at least a first host computer of the computer network, the computer-executable program code means being configured to perform the following steps on the first host computer:

generating a search result indicative of whether the information content corresponding to the specified search criterion is available on the first host computer; and

if the information content is available on the first host computer, initiating downloading the information content from the first host computer to a predetermined target computer.

The invention further relates to a computer system including a plurality of computers connected by a communications network, the system comprising

input means for specifying a search criterion on a first one of the plurality of computers;

mobile agent means for searching information content corresponding to the specified search criterion on at least a second one of the plurality of computers; and

means for initiating downloading information content from the second computer to a predetermined target computer, if the information content corresponding to the specified search criterion is found on the second computer.

The invention further relates to a computer adapted for use in a computer system described above and in the following. Preferably, the computer comprises storage means having stored therein computer-executable code means adapted to provide an execution environment for at least the first mobile agent according to the invention.

The invention further relates to a mobile agent for accessing predetermined information content on a computer network, the mobile agent comprising computer-executable program code means and a search criterion specifying the predetermined information content, the computer-executable program code means being configured to perform the following steps on at least a first host computer of the computer network:

generating a search result indicative of whether the information content corresponding to the specified search criterion is available on the first host computer; and

if the information content is available on the first host computer, initiating downloading the information content from the first host computer to a predetermined target computer.

The invention further relates to a data signal comprising a mobile agent described above and in the following.

The above-mentioned aspects of the invention are disclosed in the independent claims. As the advantages and preferred embodiments of these aspects of the invention correspond to the advantages and preferred embodiments of the method described above and in the following, these will not be repeated here.

The invention will be explained more fully below in connection with preferred embodiments and with reference to the drawings, in which:

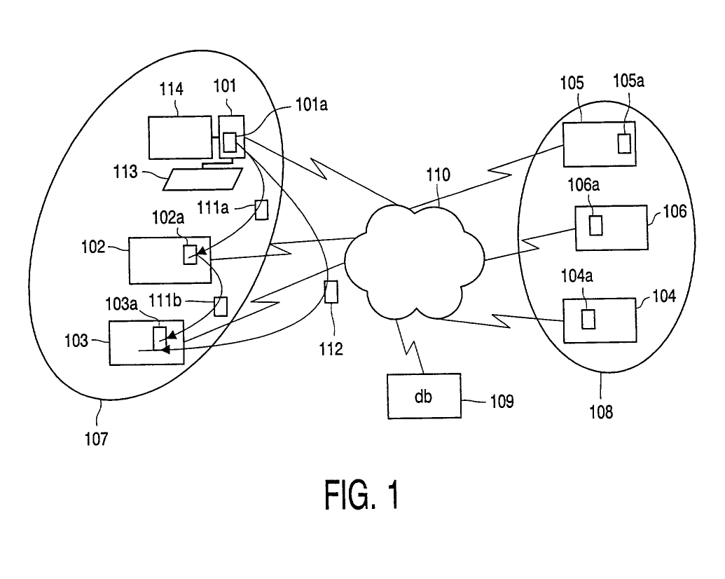

FIG. 1 shows a schematic view of a computer network according to an embodiment of the invention;

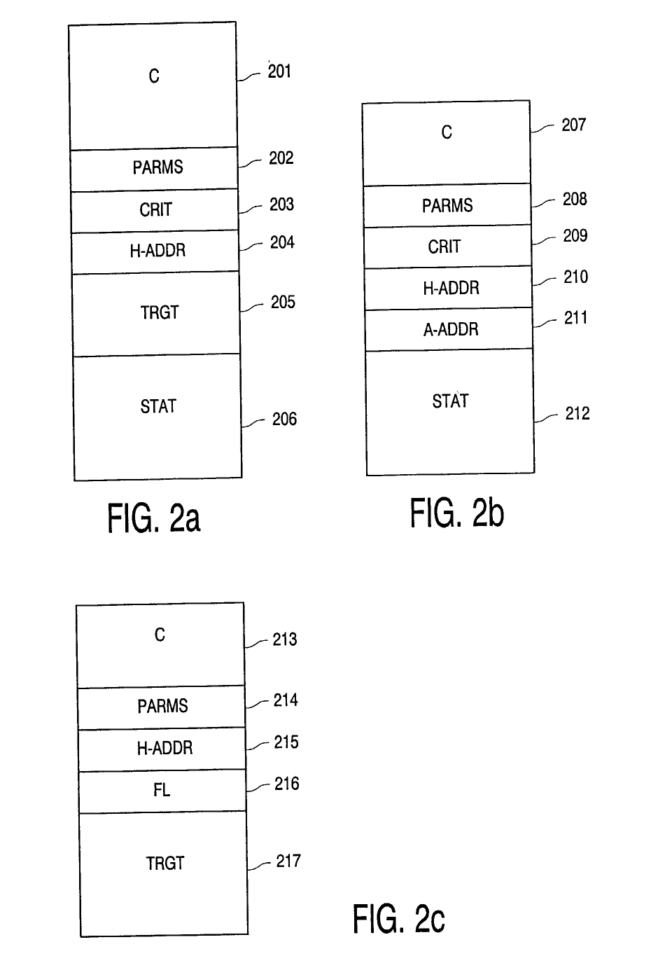

FIGS. 2a-c show schematic views of mobile agents according to an embodiment of the invention;

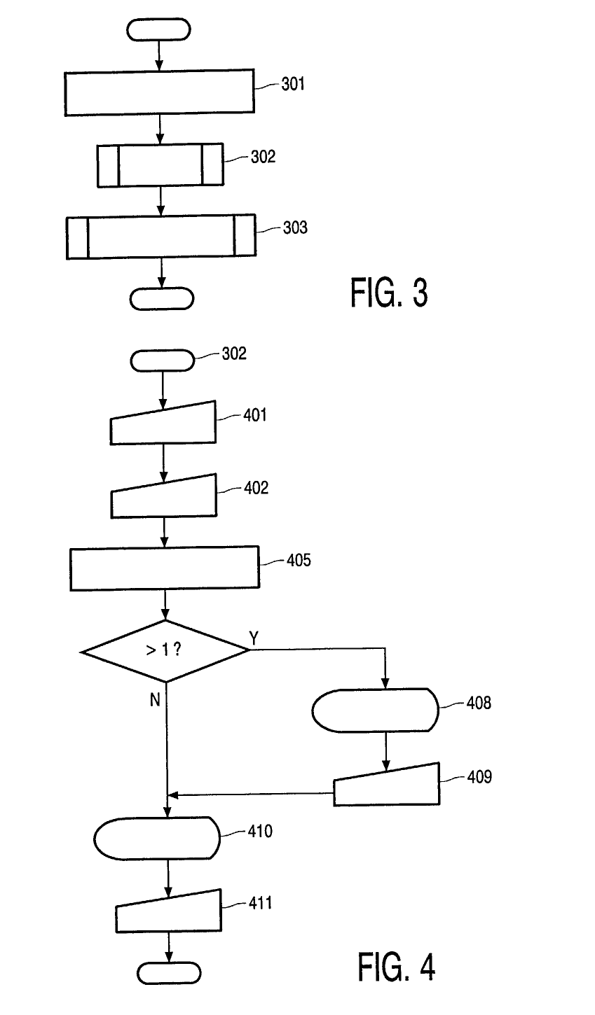

FIG. 3 shows a flow diagram of a search process according to an embodiment of the invention;

FIG. 4 shows a flow diagram of an embodiment of the sub-process 302 of FIG. 3;

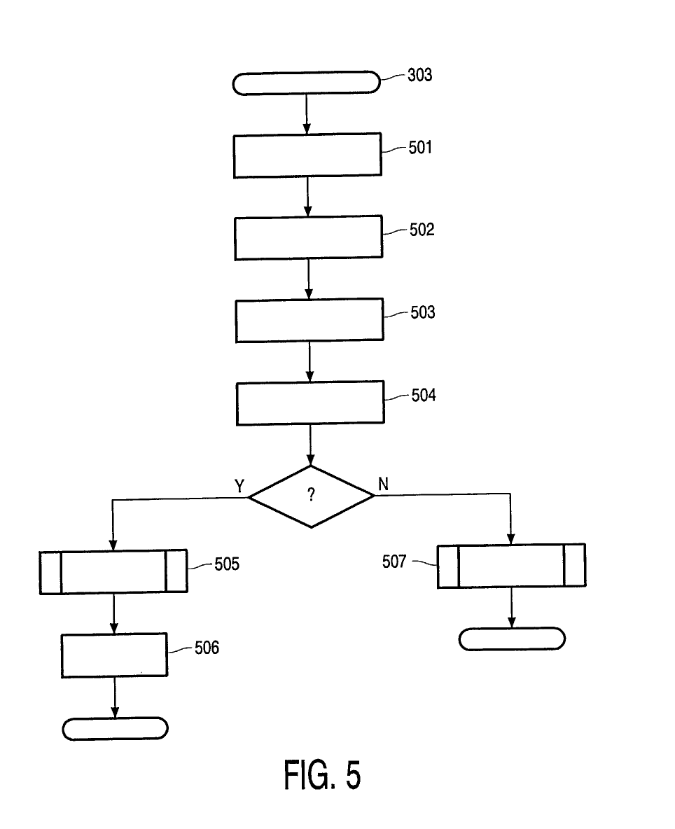

FIG. 5 shows a flow diagram of an embodiment of the sub-process 303 of FIG. 3;

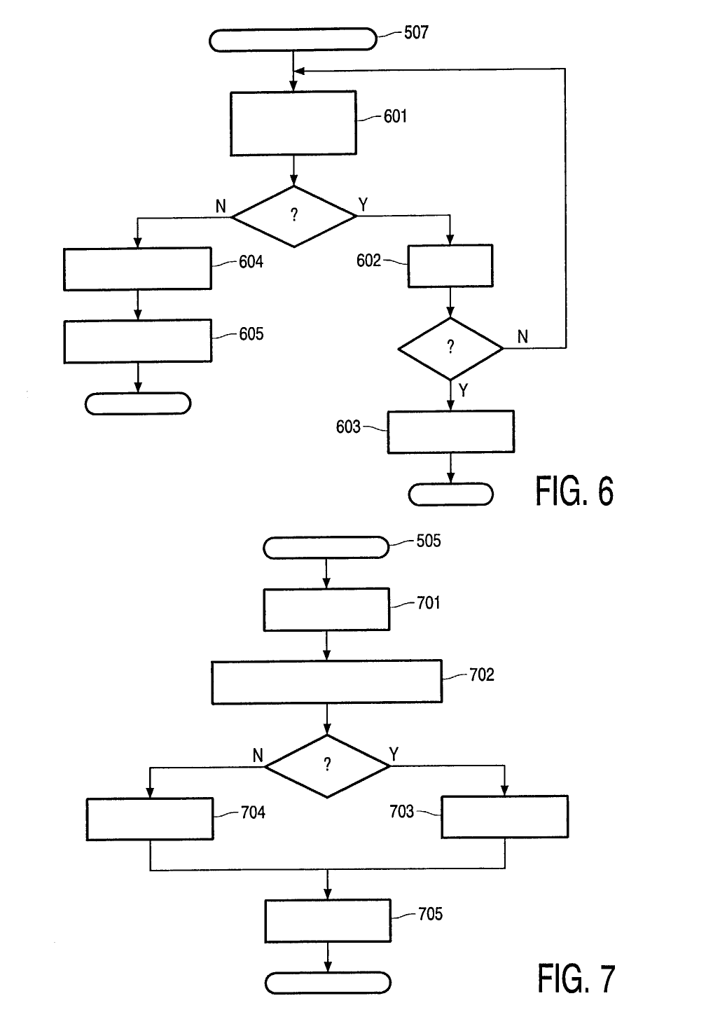

FIG. 6 shows a flow diagram of an embodiment of the sub-process 507 of FIG. 5;

FIG. 7 shows a flow diagram of a first embodiment of the sub-process 505 of FIG. 5;

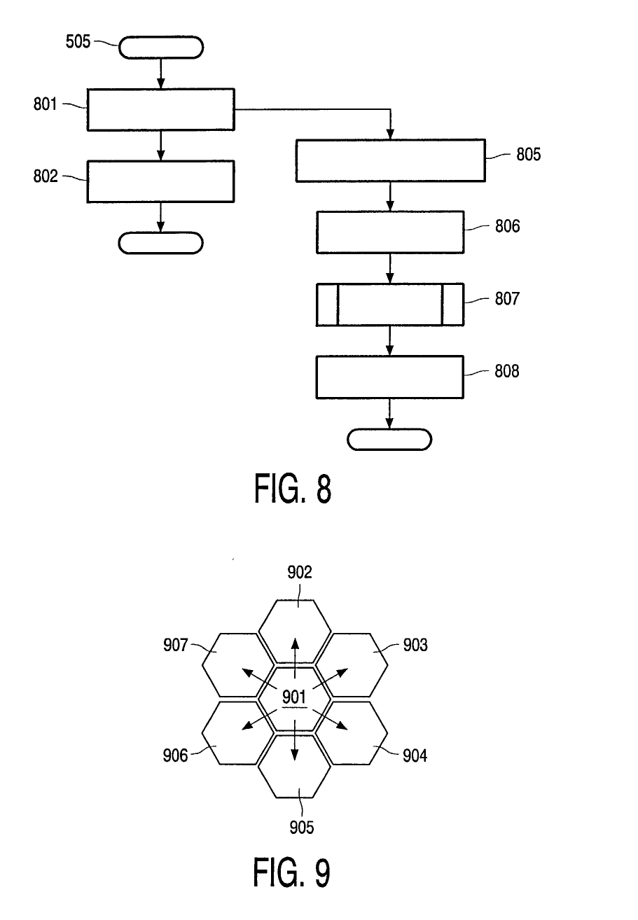

FIG. 8 shows a flow diagram of a second embodiment of the sub-process 505 of FIG. 5; and

FIG. 9 shows a schematic view of a computer network according to en embodiment of the invention.

FIG. 1 shows a schematic view of a computer network comprising host computers 101-106 participating in a system for searching and downloading music content according to the invention. The music content may be stored on different host computers, for example as MP3 files or files of another file format. Different host computers may have stored different files comprising different songs, collections or part of songs or other audio material, such as other music content, voice recordings of speeches, interviews, lectures, readings, theatre or radio plays, etc. Since many users have some music files on their PCs, a large distributed music database is achievable when a large number of users join a network community according to the invention. The community of participating users and their respective computers will be referred to as the user community. The users of the user community share their respective music files and provide resources for the execution of other user's agents. It is an advantage of the invention, that it comprises a distributed system architecture which does not depend on a central server.

The host computer 101 is connected to a keyboard or keypad 113 for receiving inputs from a user and a display 114 for presenting a graphical user interface. Alternatively or additionally, the computer 101 may comprise other input means, such as a pointing device, e.g. a computer mouse, a touch screen, or the like, and/or other display means, such as a text based display. The other computers 102-106 may also comprise input means and/or output means (not shown). Some of the host computers, e.g. database servers, may not be equipped with their own user interface, but may only be accessible via a computer network.

The host computers 101-106 are connected to the Internet 110. The connection may be wired or wireless, permanently or temporarily, e.g. via a dial-up telephone connection. The host computers 101-106 are each running a software application 101a-106a, respectively, in the following also referred to as the music agent application, which comprises an application server providing an execution environment and a number of services to mobile agents as well as access to resources such as databases, processors, etc. The music agent application further provides a user interface enabling the user to enter search criteria, initiate and supervise searches and downloads, etc. In one embodiment of the invention an execution environment may be implemented using Java and an Object Request Broker (ORB), e.g. a Voyager ORB distributed by Object Space, Inc. Other examples of agent systems include the AgentBuilder system by Reticular Systems Inc., Agent-TCL by Dartmouth University, Aglets by IBM, etc. According to the invention, the network may be logically divided into subnets 107-108 in order to increase the efficiency of the search process, thereby providing higher system performance. Preferably, a subnet may comprise hosts located in a given geographic area, where the logical division into subnets may be implemented as a set of rules, e.g. comprising the physical location of a host computer, the latency of the communication between the hosts, the presence/absence of firewalls and/or proxy servers, etc. An Example of such rule is: “Two hosts belong to the same subnet if the latency of the network communication is less than N milliseconds”, where N is a predetermined number.

When a new user wishes to become a member of the user community, the user installs the music agent application on his computer. During the installation, the user computer receives a start-up list of the addresses of at least a number of existing members of the community. When a new member starts the music agent application for the first time, the application server starts running on the new user's computer. As described in connection with FIG. 1, the application server is responsible for a proper handling of agents and providing an execution environment for them. According to one embodiment of the invention, every music agent application maintains a list of IP addresses of other computers on which the same application has been installed this list will be referred to as the ipList. These ipLists are updated each time members are added to or deleted from a community. When a music agent application goes on-line for the first time, it requests the most recent ipList of any other member of the community which already is on-line. Subsequently, the music application broadcasts information about itself to all addresses on the ipList. Hence, all other members will know about a new member and update their ipLists accordingly. In this way, the problem of introducing a new member to the community and of updating ipLists is solved.

According to one embodiment of the invention this mechanism only applies within a subnet; different subnets communicate using a different approach. This will be described in greater detail in connection with FIG. 9.

The actual search process according to the invention may be illustrated by an example: A user of the host computer 101 may initiate a search for a certain song, e.g. by entering a search criterion via the keyboard 113, by selecting a song from a list of songs presented by the music agent application 101 a via the display 1 14, or the like. In response to the user input, a search process is initiated from host 101 by dispatching a mobile agent 111a-b, as will be described in greater detail in connection with FIGS. 3-4. According to one embodiment of the invention, the search agent 111a-b visits the hosts 102-103 of the subnet 107 which the host 101 belongs to.

The search within a subnet may proceed according to an itinerary included in the data part of the mobile agent as described in connection with FIG. 2a. If the desired content is not found on any of the hosts 102-103, the search is continued on the hosts of the subnet 108. In this case, according to one search strategy, the address of one host (e.g. 105) of the subnet 108 is appended to the itinerary of the mobile agent. When the host 105 is visited, a list of the addresses of the subnet 108 are retrieved from host 105 and added to the itinerary of the mobile agent. The search is then continued. According to another embodiment of the invention, each host in a subnet includes or has access to storage means having stored thereon the same information as any other host of that subnet. Preferably, the information includes a list of all songs on all hosts of the subnet. According to this embodiment, an agent only needs to visit one host of that subnet in order to search a song in the subnet, thereby further reducing the network traffic. There may still be advanced types of searches, though, where an agent may visit all the hosts of a subnet, if necessary. If the desired song is found on a host computer, according to one embodiment of the invention, a download agent 112 is dispatched from the user's computer 101 to the host computer where the song was found. In the example of FIG. 1, this is the host computer 103.

The computer network further comprises a database host 109 comprising a music information database.

The music information database may comprise a searchable database of known audio titles, i.e. titles of albums, names of artists, titles of songs included in the albums, length of songs, etc. The music information database may be used during the specification of a search criterion in order to avoid unsuccessful searches due to erroneous search criteria, e.g. due to misspelled titles or mismatches in artist names and CD titles, etc. A possible use of the music information database will be described in connection with FIG. 4. It is an advantage of the invention that the content of the music information database does not need to be synchronised with the actual music content available on the host computers, as the database is not used during the actual search but merely in order to generate a better basis for the search. Hence, the music information database may be provided by a third party, independently of the agent based search system, but providing an interface to the user interface where the search criterion is specified. In a preferred embodiment of the invention, the music information database provides information in text form.

FIGS. 2a-c schematically show different examples of mobile agents according to the invention. FIG. 2a illustrates an agent capable of searching and downloading music content. The agent comprises a code section 201 and data sections 202-206 comprising a search criterion 203, the IP address of the host having launched the agent 204, i.e. the home address of the agent, a list of alternative download targets 205, and an itinerary and status section 206 with a list of hosts to be visited during the search and an indication of which hosts already have been visited. The code section comprises computer-executable code which is executed in cooperation with the execution environment of the respective host. The list of alternative download targets 205 may comprise a list of IP addresses, e-mail addresses, and/or the like, indicating targets to which any music files found during the search should be downloaded or mailed. Each entry of the itinerary list 206 may comprise a status flag indicating whether a host has already been visited. Additional status flags may provide further information, e.g. whether a visit to a host has been attempted without success, e.g. because the host was down or off-line. Alternatively or additionally, hosts addresses of hosts which already have been visited may be removed from the itinerary in order to reduce the size of the mobile agent.

Additionally, the data section may comprise other parameters 202, such as an agent ID, time-out values, maximum retry values if hosts are down, etc. Some of the features of mobile agents include:

Object passing: When a mobile agent moves, the whole object is passed; that is, its code, data, execution state and travel itinerary are passed together.

Autonomy: A mobile agent contains sufficient information to decide which tasks to perform on a host, where to go next and when to go there.

Asynchrony: A mobile agent has its own thread of execution and can execute asynchronously.

Local interaction: A mobile agent interacts with other mobile agents or stationary objects of a host locally. An agent is able to co-operate with other agents in order to perform complex or dynamic tasks. For example, agents may read from and write to a shared block of memory on each host, thereby being able to co-ordinate with other agents executing on that host and to leave information behind for subsequent visitors.

Disconnected operation: A mobile agent can perform its tasks, whether or not the network connection its host is open. If the network connection is closed and a mobile agent needs to move, it can wait until the connection is reopened.

Parallel execution: More than one mobile agent can be dispatched to different sites to perform tasks in parallel.

Adaptability: An agent is able to identify and use resources of different types of hosts, e.g. running different operating systems, etc.

FIG. 2b shows an example of an agent only capable of searching for music content. When this agent has found the desired content on a given host, it sends a message to a predetermined agent base, i.e. a predetermined host such as the home address of the agent, thereby causing the execution environment of the agent base to transfer a download agent to the corresponding host which, in turn, initiates the download process. This will be described in greater detail in connection with FIG. 8. Hence, the code section 207 of this search agent does not need to comprise executable code for the downloading of files. Furthermore, no list of alternative download targets is required in this embodiment, as this is information which is only required for the download agent. The search agent only comprises the address 211 of the agent base. Consequently, it is an advantage of this embodiment that the size of agents which may repeatedly be transmitted over the network is reduced, thereby reducing the network traffic. The search agent of FIG. 2b further comprises data sections comprising parameters 208, a search criterion, the home address 210 of the agent, and an itinerary and status section 212. These sections correspond to the sections 202, 203, 304, and 206, respectively, of the agent in FIG. 2a.

FIG. 2c illustrates an agent used for downloading music content, e.g. according to the method described in connection with FIG. 8. The download agent comprises a code section 213 with executable code. The download agent further comprises data sections 214-217 including a parameter section 214 and a home address 215 like the corresponding sections 202 and 204, respectively, of FIG. 2a. The section 216 comprises the address of the file or files to be downloaded, and section 217 comprises a target address or a list of alternative target addresses, specifying where the file should be downloaded to.

In another embodiment of the invention, different types of mobile agents may be used which are specialised on different tasks, thereby providing a different division of labour. For example, a system may comprise three types of agents: provider agents, delivery agents and search agents. According to this embodiment, the provider agents may be adapted to access information from different sources such as mp3.com, Altavista, etc. The delivery agents may be adapted to perform user-related tasks, such as accessing mailboxes, reading information from them and store information in them, or how to store information on alternative computers. The search agents may be adapted to communicate with users and to find provider and delivery agents.

FIGS. 3-8 show flow diagrams of a process of searching and retrieving music content according to an embodiment of the invention.

FIG. 3 illustrates the overall process including the steps of starting the agent application 301, selecting a search target 302, and the actual searching and downloading 303.

FIG. 4 shows a flow diagram of an embodiment of the sub-process 302 in FIG. 3 of selecting a search target. Initially, in step 401, the user enters a search criteria via the user interface of his computer. In the example of FIG. 4, it is assumed that the user enters the title of a music album. It is understood, however, that other search criteria may be used. Examples of other search criteria include: search by artist name, song title, genre, content (phrase) or refrain of a song, search by year, search according to a set of auxiliary criteria, such as download possible with/without charges, quality of compression, etc. Additionally, combinations of the above search criteria may be used. Preferably, the search criteria are entered and displayed via a graphical user interface of the music agent application with appropriate text boxes for the input of the criteria. In the subsequent step 402, the user initiates the search process, e.g. by clicking with a pointing device on a “Search” button of the graphical user interface or a corresponding button of a keyboard, keypad, or the like. In response to this user input, in step 405, a query is sent by the music agent application to a predetermined music database, for example a database accessible via the Internet such as www.allmusic.com, which returns a list of possible matches. In the example of FIG. 4, if there are more than one album which match the search query, a list of possible albums may be displayed on the screen (step 408). Subsequently, in step 409, the user may select one of the displayed albums, e.g. by clicking on the selected item on the list with a pointing device, e.g. a computer mouse, a track ball, via a touch screen, or the like. In the subsequent step 410, the songs of the selected album are displayed. If the database query resulted in a single match only, the songs of the matching album may be displayed directly. In step 411, the user may select one or more songs from the displayed list of songs and add them to the search criterion.

It is an advantage of the use of a music information database during the specification of the search criterion, that the presentation of unwanted results during the actual search is avoided. According to this embodiment, a search string is defined iteratively using an information database, thereby avoiding the reception of a large collection of links to songs or unrelated sites which may not fit the user's taste or preference and, thus, are not candidates for a download. Furthermore, prior to the actual search by the agent, the spelling and consistency of the search criterion is checked against the contents of the music information database.

Additionally or alternatively, browsing facilities may be provided to the user. For example, the user may only specify an artist's name or CD's title as a search criterion, causing the query to return a list of albums or artists.

In another embodiment of the sub-process 302, the step of querying the database may be performed by a query agent which travels to one or a number of predetermined hosts, queries a number of different databases, and returns with the corresponding results.

FIG. 5 shows a flow diagram of an embodiment of the sub-process 303 in FIG. 3 of searching and downloading the desired music content. When the user has specified a suitable search criterion for a search, e.g. by the method described in connection with FIG. 4, the search may be initiated, e.g. by the user pressing a “dispatch” button, thereby causing a mobile agent to be conFigured and dispatched. Preferably, the mobile agent is conFigured with the search criterion and other predetermined parameters. Examples of additional parameters comprise an itinerary which may be extracted from the ipList of addresses of other computers of the user community, as was described in connection with FIG. 1. When the mobile agent arrives on a host computer of its itinerary, in step 501, it automatically starts executing the program code of its code section. In step 502, the host computer is marked visited in the itinerary of the mobile agent in order to avoid visiting a host computer twice. In the subsequent step 503, the mobile agent identifies, e.g. by querying the music agent application of the visited host, which directories in the directory structure of the current host may be searched for music contents. This allows a user to restrict access by other user's agents to certain directories, thereby increasing the security and privacy of the system. In step 504, the identified directories are searched for files comprising the desired content according to the search criterion. If the desired content was found, the downloading of the corresponding files is initiated in step 505. This completes the task of the agent. Consequently, the agent may terminate execution in step 506 and self-destruct. If the desired content is not found on the present host, the mobile agent initiates a transfer to another host of its itinerary (step 507), e.g. by requesting a transmission from the execution environment of the current host.

It is an advantage of the invention that the user does not need to be directly involved in the search procedure. However, in a preferred embodiment, status information about the search and download process may be presented to the user. For example, the search agent may send status messages back to the home address, e.g. upon arrival and/or departure at a host computer, when a matching file is found, before the agent self-destructs, and/or upon occurrence of other predetermined events. In another embodiment, an agent may leave messages on a predetermined web server which, preferably, remains on-line at any time and which functions as an agent message board. Such a message board may further be used to control agents. For example, a user may post commands to stop a certain agent. Such a mechanism may even be used, when the agent or the user is temporarily off-line. Alternatively, the agent can leave a trail of proxies by which its current address can be found.

FIG. 6 shows a flow diagram of an embodiment of the sub-process 507 in FIG. 5 of transferring to a new host computer. According to the embodiment illustrated in FIG. 6, in step 601 a new host is selected from the itinerary of the mobile agent. If there are no hosts left on the itinerary which have not yet been visited and which are not marked unreachable, the mobile agent sends a message to its home address that the search has failed (step 604) and, subsequently, it terminates execution and self-destructs (step 605). If a host is found on the itinerary, the mobile agent initiates its transmission to the new host (step 602). If the transmission is successful, the execution of the agent on the current host is terminated (step 603). Preferably, these tasks are managed by the agent execution environment of the current host. If the transmission fails, for example because the target host is off-line, execution may continue in step 601 by selecting an alternative host or by waiting for a predetermined period of time. Preferably, the number of unsuccessful trials is stored in connection with the itinerary, and when a host could not be reached after a predetermined number of times, the host may be marked unreachable in the itinerary.

It is noted, that alternative methods of managing the transfer of agents and of selecting hosts may be used within the scope of the invention, e.g. a method based upon subnets as will be described in connection with FIG. 9.

FIG. 7 shows a flow diagram of an embodiment of the sub-process 505 in FIG. 5 of downloading the music content found on one of the host computers to a target host from the list of target hosts. In the initial step 701, the file to be downloaded is compressed. Subsequently, a target address is selected, e.g. from a list of target hosts in the data section of the agent. In a preferred embodiment, the default destination is the home address of the agent, i.e. the user computer of the user who has dispatched the mobile agent. If the user computer and the current host computer are both on-line and the song has been found, the download may be initiated with the home address of the agent as a destination. In step 703, the agent sets up the connection between the user computer and the source computer where the song has been located. For example, the agent may send a request to the execution environment of the user computer. If the user computer is ready to receive the song, the agent starts the download. After the user computer has received the song, it sends a message to the agent that the download has been finished, causing the agent to destroy itself (step 705). When the direct download is not possible, e.g. because the user computer is off-line, the agent may select an alternative destination from the list of alternative targets. Alternative targets may include another user's computer, a mailbox, or a remote storage. A mailbox may, for example be a mailbox provided by a free mail service. Alternatively or additionally, a user may have agreed with a friend, to allow agents to download songs to each other's when one of the users is off-line. Alternatively or additionally, services that are always available on the Internet and provide storage space may be used as temporary storage.

In the above cases, when the user is on-line again, the agent may start downloading the songs from the temporary storage to the user's computer. Preferably, when the song appears on the user's computer, the user is notified, e.g. by a sound and/or a visual indication such as a flag above a tray icon.

In the example of FIG. 7, if the agent cannot find a suitable download address on the list of alternative download addresses, the file is attached to an email and mailed to a predetermined email address (step 704).

FIG. 8 shows a flow diagram of an alternative embodiment of the sub-process 505 in FIG. 5, based on a second agent responsible for the downloading of the localised music content. According to this embodiment, in step 801, the search agent sends a message to its home address or, alternatively, another predetermined agent base. The message comprises an address of the location where the desired music content was found. After sending the message, the search engine may terminate (step 802). In response to the message, in step 805, the host computer corresponding to the home address or the agent base dispatches a download agent directly to the intended location where the song is located. From this point onwards the download process is the responsibility of the download agent. The download agent starts execution on the host where the song was found (step 806), performs the download process (step 807), and terminates (step 808). The download process 807 may be performed according to the method described in connection with FIG. 7. It is an advantage of this embodiment, that the search agents require less code and, thus, are smaller. It is a further advantage of this embodiment that, if the desired music content is found on more than one host, e.g. by different copies of the dispatched agent, unnecessary additional downloads of the same content may be avoided. At the home address, the host computer may dispatch a download agent to the first identified location and ignore any further messages indicating alternative locations. Alternatively, the user computer may wait for a predetermined period of time after reception of the first message. Subsequently, one of the possible alternative locations received during this period may be selected, e.g. based on network topology information, subnet information, or the like. It is an advantage of this strategy, that the download time and the network traffic may be reduced.

In another embodiment of the invention, the download process is not initiated automatically but requires an accept by the user.

Furthermore, in a preferred embodiment, information about the previous download sources are stored on the user's computer. This information may be used in subsequent searches, e.g. to determine the order of host computers on the itinerary of a search agent according to the historic hit rate, thereby increasing the efficiency of the search process.

FIG. 9 shows a schematic view of a computer network according to a preferred embodiment of the invention. FIG. 9 schematically illustrates a number of subnets 901-907 of a computer network according to the invention. As described in connection with FIG. 1, the subnets may be defined on the basis of topology information or other suitable criteria. According to this embodiment, each subnet has assigned to it a number of other subnets as neighbours. For example, if the subnets are based on network topology or geographic location, the neighbours of subnet 901 may be all subnets 902-907 directly connected to the subnet 901. Correspondingly, the subnets 901, 902, and 904 correspond to neighbours of the subnet 903. In another example, if the subnets are based on genre, neighbouring subnets may be defined as subnets related to similar genres.

The above concept of subnet neighbourhood may be utilised in the communication between the subnets and to increase the efficiency of the search process.

As was described in connection with FIG. 1, according to a preferred embodiment of the invention, every computer within a subnet with the music agent application on it, maintains a list of addresses of all other computers of this subnet. Furthermore, every computer in a subnet acts as a gateway for agents to neighbouring subnets. This is different from a usual approach applied for networks using the Internet Protocol, where there typically is a single gateway for each subnet consequently, it is a problem of the above approach that, if the gateway is down, an entire subnet may be unreachable. Hence, the present approach, where each host computer acts as a gateway, provides better reliability, since having multiple gateways increases the reachability of a subnet: A subnet is reachable whenever at least one computer of that subnet is on-line. Furthermore, the present approach has the advantage that the network communication payload is distributed between the gateways of a subnet, which leads to a better performance.

Still referring to FIG. 9, every subnet 901-907, respectively, has a limited number of neighbour subnets. In the example of FIG. 9, the subnet 901 has 6 neighbours. It is a responsibility of each subnet, to maintain the proper relationships with neighbouring subnets. This requirement may be expressed as follows: At any given moment, a subnet should be able to contact all its neighbour subnets, i.e. from any computer of a given subnet, it should always be possible to contact at least one computer of any of its neighbour subnets, provided that at least one computer of the respective neighbour subnets is on-line.

The above requirement may be satisfied by adapting each computer of a subnet to maintain a pool of addresses of at least one computer from every neighbour subnet. Preferably, in order to improve the reliability of the system, every computer of a subnet should keep the addresses of all computers from all neighbour subnets in addition to the addresses of all other computers of the subnet the computer belongs to itself. These addresses may be updated in regular time intervals by messaging between the gateway hosts of the neighbour subnets.

According to this embodiment, for an agent to be transferred to a neighbour subnet, the agent is not required to know any IP addresses of that neighbour subnet. Instead, the host of a current subnet on which the agent resides performs the necessary lookup of the address of a host of the destination subnet. If the first destination host from the list is off-line, the current host tries another host, until it can contact any host of the destination subnet. When a host from the destination subnet was contacted, the current host transfers the agent to it. Consequently, it is an advantage of this embodiment of the invention that it provides a reliable mechanism for the communication between subnets. Furthermore, it is an advantage of this embodiment, that the agents do not need to maintain a detailed itinerary, thereby reducing the size of the agents.

Still referring to FIG. 9, the above concept of neighbourhood may further be exploited in the definition of efficient search strategies. For example, a search is assumed to be initiated in subnet 901. If the desired content is found in the subnet 901, the download process is initiated. Otherwise the mobile agent initiates the generation of a number of copies of itself. These copies will be referred to as clones. At least one clone is then transmitted to a predetermined set of other subnets. In the example of FIG. 9, the clones may be transferred to all neighbour subnets 902-907 of the initial subnet 901. Subsequently, the cloned agents repeat the above process in the other subnets, thereby potentially generating new clones. According to this embodiment, a search agent only needs to know its home address, i.e. the address where the search result should be reported to. According to this embodiment, if a search inside a subnet was not successful, the agent terminates itself. Preferably, according to this embodiment, supportive mechanisms for the cloning should exist within every subnet. For example, every subnet should keep track of agents that have visited the subnet. Each mobile agent may correspond to an ID which is preserved during the process of cloning, i.e. an ID is unique for a family of cloned agents. A subnet should not accept any agents with an ID which has already visited that subnet. This guaranties that a given search agent or its clones will visit each subnet only once. Furthermore, to support an agent in the cloning operation, a subnet should maintain a list of neighbouring subnets and maintain its connections with all neighbouring subnets. It is an advantage of this embodiment, that the individual agents only need to carry little information, thereby reducing their size and increasing the efficiency of the method. It is a further advantage of this embodiment that the search is performed in a productive way, as several subnets are searched in parallel.

It should be noted that the invention was described in connection with the example of searching for music content on the Internet. It is understood, however, that the searching of other information content on other computer networks also is within the scope of the invention.

1. A method of retrieving information content in a computer network, the method comprising the steps of
specifying (302) a search criterion on a user computer (101) of the computer network;
transmitting a first mobile agent (11a) including computer-executable program code means (201, 207) and the search criterion (203, 209) to at least a first host computer (102, 103, 104, 105, 106) of the computer network;
generating (504) a search result by means of the received first mobile agent indicative of whether the information content corresponding to the specified search criterion is available on the first host computer; and
if the information content is available on the first host computer, initiating downloading (505) the information content from the first host computer to a predetermined target computer (101).

2. A method according to claim 1, further comprising the step of initiating (507) transmitting a second mobile agent (111b), corresponding to the first mobile agent, from the first host computer to at least a second host computer of the computer network, if the information content is not available on the first host computer.

3. A method according to claim 1, wherein the computer network is logically divided into a number of subnets (107, 108, 901, 902, 903, 904, 905, 906, 907), a first one (107, 901) of the number of subnets comprising the first host computer; and the method further comprises the steps of
searching for the information content on the host computers of the first subnet;
initiating transmitting a second mobile agent, corresponding to the first mobile agent, from the first host computer to at least a first host computer of a second subnet, if the information content is not available on the host computers of the first subnet.

4. A method according to claim 3, the step of initiating transmitting a second mobile agent further comprising the steps of
generating a predetermined number of copies of the first mobile agent;
transmitting the generated copies of the first mobile agent from the first host computer to respective ones of a predetermined subset of the number of subnets.

5. A method according to claim 4, the method further comprising the steps of
assigning an identification code to the generated copies by the first host computer of the first subnet, the identification code corresponding to an identification code of the first mobile agent;
registering by at least a second host computer of the first subnet the identification codes of any mobile agent searching the first subnet;
rejecting mobile agents having an identification code corresponding to the identification code of the first mobile agent to search the host computers of the first subnet.

6. A method according to claim 3, wherein at least a second one of the host computers of the first subnet comprises storage means having stored thereon a list of the information content available on the host computers of the first subnet; and the step of searching for the information content on the host computers of the first subnet comprising the step of searching the list of the information content stored on the second host computer.

7. A method according to claim 1, the step of initiating downloading the information content further comprising the steps of
transmitting (801) a message indicative of a location of the information content from the first host computer to the user computer;
in response to the received message transmitting (805) a third mobile agent (112) to the first host computer of the computer network, the third mobile agent being conFigured to initiate downloading (807) the information content from the indicated location.

8. A method according to claim 1, wherein the step of specifying a search criterion further comprises the steps of
receiving a first input (401) from a user indicating a preliminary search criterion;
querying (405) a database on a database computer (109) on the basis of the preliminary search criterion resulting in a list of corresponding search criteria;
selecting (411) the search criterion from the list of corresponding search criteria.

9. A method according to claim 1, wherein the information content comprises audio content.

10. A method according to claim 1, further comprising the step of transmitting status information about the searching from the second computer to the user computer.

11. A method of accessing information content on a computer network from a user computer, the method comprising the steps of
specifying a search criterion on the user computer; and
transmitting a first mobile agent including computer-executable program code means and the search criterion to at least a first host computer of the computer network, the computer-executable program code means being conFigured to perform the following steps on the first host computer:
generating a search result indicative of whether the information content corresponding to the specified search criterion is available on the first host computer; and
if the information content is available on the first host computer, initiating downloading the information content from the first host computer to a predetermined target computer.

12. A computer system including a plurality of computers (101, 102, 103, 104, 105, 106) connected by a communications network (110), the system comprising
input means (113) for specifying a search criterion on a first one (101) of the plurality of computers;
mobile agent means (111a, 111b) for searching information content corresponding to the specified search criterion on at least a second one of the plurality of computers; and
means (112) for initiating downloading information content from the second computer to a predetermined target computer, if the information content corresponding to the specified search criterion is found on the second computer.

13. A computer adapted for use in a computer system according to claim 12.

14. A mobile agent for accessing predetermined information content on a computer network, the mobile agent comprising computer-executable program code means and a search criterion specifying the predetermined information content, the computer-executable program code means being conFigured to perform the following steps on at least a first host computer of the computer network:
generating a search result indicative of whether the information content corresponding to the specified search criterion is available on the first host computer; and
if the information content is available on the first host computer, initiating downloading the information content from the first host computer to a predetermined target computer.

15. A data signal comprising a mobile agent according to claim 14.
